(19) United States
(12) Patent Application Publication
(10) Pub. No.: US 2026/0331474 A1
(43) Pub. Date: Oct. 22, 2026

(54) ANODE MATERIAL, PREPARATION METHOD THEREOF AND LITHIUM-ION BATTERY

(71) Applicants: BTR NEW MATERIAL GROUP CO., LTD., Shenzhen (CN); DINGYUAN NEW ENERGY TECHNOLOGY CO., LTD., Huizhou (CN)

(72) Inventors: Xiaotai SHI, Shenzhen (CN); Chunlei PANG, Shenzhen (CN); Tengyu LIANG, Shenzhen (CN); Jingwei WANG, Shenzhen (CN); Jianguo REN, Shenzhen (CN); Xueqin HE, Shenzhen (CN)

(73) Assignees: BTR NEW MATERIAL GROUP CO., LTD., Shenzhen (CN); DINGYUAN NEW ENERGY TECHNOLOGY CO., LTD., Huizhou (CN)

(21) Appl. No.: 19/468,381

(22) Filed: Feb. 3, 2026

Related U.S. Application Data
(63) Continuation of application No. PCT/CN2024/142521, filed on Dec. 25, 2024.

(30) Foreign Application Priority Data
Dec. 27, 2023 (CN) 202311830608.2

(51) Int. Cl. H01M 4/38; H01M 4/02; H01M 4/36; H01M 4/48; H01M 4/58; H01M 4/62; H01M 10/0525

(52) U.S. Cl. CPC H01M 4/386; H01M 4/366; H01M 4/48; H01M 4/5825; H01M 4/625; H01M 10/0525; H01M 2004/021; H01M 2004/027

(57) ABSTRACT

Provided is an anode material, a preparation method thereof and a lithium-ion battery. The anode material includes an active material including Si, O and metal M, where the metal M includes Mg, Ca and Cu. In the anode material, a mass content of Mg is m_{Mg}, a mass content of Ca is m_{Ca}, and a mass content of Cu is m_{Cu}, where 0<m_{Ca}/m_{Mg}<0.1, and 0<m_{Cu}/m_{Mg}<0.01Mg, Ca and Cu are introduced into the active material, and a ratio of Mg, Ca and Cu is limited within a proper range.

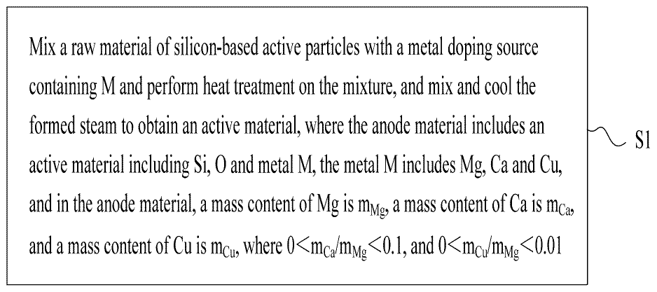

### CROSS-REFERENCE TO RELATED APPLICATIONS

The present application is a continuation of International Patent Application No: PCT/CN2024/142521 filed on Dec. 25, 2024, which claims priority from Chinese patent application No. 2023118306082 filed on Dec. 27, 2023, the entire contents of each of which are incorporated herein by reference for all purposes.

### TECHNICAL FIELD

The present application relates to the technical field of lithium batteries, and particularly relates to an anode material, a preparation method thereof and a lithium-ion battery.

### BACKGROUND

Having the highest lithium storage capacity so far and a relatively low voltage platform, the silicon-based anode material is one of the hottest spots for research on anode materials of the lithium-ion battery. However, commercial applications of the silicon material are limited by its high volume expansion rate (>300%) and low conductivity. Theoretically, SiO has a capacity lower than Si, but the strength of a Si—O bond is twice that of a Si—Si bond. Moreover, the Li₂O compound produced in the first-cycle reaction can alleviate the volume expansion. Therefore, SiO has much better cycle performance than Si. However, at the same time, excessive Li₂O may increase the consumption of Li ions in the cathode material during the initial charging, thereby increasing the irreversible capacity of the material and reducing the initial coulombic efficiency.

In the existing art, a possible choice is to dope some reductive Mg into the silicon-based anode material, and distribute Si, O and Mg uniformly in the anode material, thereby increasing the irreversible capacity of the anode material. However, although the initial coulombic efficiency is improved to a certain extent, the silicon-based anode material prepared thereby still has the problems of low conductivity and poor cycle performance.

### SUMMARY

The present application provides an anode material, a preparation method thereof and a lithium-ion battery, which can help to improve the initial coulombic efficiency, conductivity and cycle performance of the anode material comprehensively, thereby solving the problem that the existing anode materials fail to achieve a balance among initial coulombic efficiency, conductivity and cycle performance.

In a first aspect, an embodiment of the present application provides an anode material, including an active material including Si, O and metal M, where the metal M includes Mg, Ca and Cu;
in the anode material, a mass content of Mg is m_{Mg}, a mass content of Ca is m_{Ca}, and a mass content of Cu is m_{Cu}, where 0<m_{Ca}/m_{Mg}<0.1, and 0<m_{Cu}/m_{Mg}<0.01.

In a second aspect, the present application further provides a preparation method for an anode material, including:
mixing a raw material of silicon-based active particles with a metal doping source containing M and performing heat treatment on the mixture, and mixing and cooling the formed steam to obtain an active material, where the anode material includes an active material including Si, O and metal M, where the metal M includes Mg, Ca and Cu, and in the anode material, a mass content of Mg is m_{Mg}, a mass content of Ca is m_{Ca}, and a mass content of Cu is m_{Cu}, where 0<m_{Ca}/m_{Mg}<0.1, and 0<m_{Cu}/m_{Mg}<0.01.

In a third aspect, the present application further provides a lithium-ion battery, including the anode material as described above, or an anode material prepared by the above preparation method.

Compared with the existing art, the technical solutions of the present application have at least the following technical effects:

In the anode material of the present application, Mg, Ca and Cu are introduced into the active material, and a ratio of Mg, Ca and Cu is limited within a proper range, so that the initial coulombic efficiency, conductivity and cycle performance of the anode material are improved comprehensively. In the present application, the introduced Mg and Ca help to reduce a content of silicon oxide in the anode material so that the amount of lithium consumed by the silicon oxide in the anode material is reduced, and the initial coulombic efficiency of the anode material is improved. Compared with Mg atoms, Ca atoms have lower electronegativity and may produce higher bond energy with O and/or Si atoms, which is more favorable for stabilizing an atomic cluster structure, so that the structural stability and cycle performance of the anode material are improved. When m_{Ca}/m_{Mg}>0.1, the capacity and the initial coulombic efficiency of the anode material are both reduced. As a doping element, Cu may be present in the anode material in the form of at least one compound of copper oxide, cuprous oxide, cupric silicate, or copper silicide. Compared with Mg atoms, Cu atoms in the Cu compound have obviously more electron shells and a lower electron transition energy barrier, i.e., a lower capture capability of electrons, which means that an outermost layer of free electrons has good mobility. When m_{Cu}/m_{Mg}>0.01, the structural stability of the anode material will be reduced. Therefore, the doping of Cu can improve the conductivity and cycle performance of the silicon oxide anode material.

In the preparation method of the present application, proper amounts of Mg, Ca and Cu are doped into the silicon-based active particles in the process of preparing the active material of the anode material, so that the ratio of Ca, Cu and Mg in the finally prepared anode material is controlled within an ideal range, and the prepared anode material has relatively high initial coulombic efficiency and conductivity, excellent cycle performance, and high lithium intercalation and deintercalation rates. In the technical solutions of the present application, the introduced Mg and Ca will react with the silicon oxide in the silicon-based active particles to generate elemental silicon, which can help to reduce a content of silicon oxide in the anode material so that the amount of lithium consumed by the silicon oxide in the anode material is reduced, and the initial coulombic efficiency of the anode material is improved.

### BRIEF DESCRIPTION OF THE DRAWINGS

The accompanying drawings, which constitute a part of the present application, are illustrated here to provide a further understanding of the application, and exemplary examples of the present application and description thereof serve to explain the present application instead of limiting the application inappropriately. In the drawings:

The FIGURE is a diagram showing a preparation process of an anode material according to the present application.

### DETAIL DESCRIPTION OF THE INVENTION

It should be noted that the examples of the present application and features therein may be combined with each other as long as they are not contradictory. To better understand the technical solutions of the present application, the examples of the present application will be described in detail below with reference to the accompanying drawings.

It should be understood that the examples described are merely some, but not all, of the examples of the present application. All other examples obtained by a person of ordinary skill in the art based on the examples in the present application without any creative labor belong to the protection scope of the present application.

The terminology used in the examples of the present application is for the purpose of describing particular examples only, and is not intended to limit the present application. As used in the examples of the present application and the appended claims, the singular forms “a”, “an”, and “the” are intended to include the plural forms as well, unless the context clearly indicates otherwise.

It should be understood that the term “and/or” as used herein is merely to describe an association relationship of associated objects, which may include three relationships. For example, A and/or B may refer to: A alone, A and B, or B alone. In addition, the character “/” as used herein generally indicates that the former and latter associated objects are in an “or” relationship.

In the existing art, a possible choice is to dope some reductive Mg into the silicon-based anode material, and distribute Si, O and Mg uniformly in the anode material, thereby increasing the irreversible capacity of the anode material. However, although the initial coulombic efficiency is improved to a certain extent, the silicon-based anode material prepared thereby still has the problems of low conductivity and poor cycle performance.

In this regard, those skilled in the art have also tried to improve the conductivity and cycle performance of the anode material by adjusting the content distribution of various elements in the anode material, but the above technical problem remains unsolved, mainly because: various elements in the anode material are mutually associated and collaborated to influence the comprehensive performance of the material, and for the influences of multiple parameters, it is difficult to obtain a properly controlled range of each parameter in the product by a simple test means.

In view of the above technical problem, in a first aspect, the present application provides an anode material.

In an embodiment of the present application, the anode material includes an active material including Si, O, C and metal M, where the metal M includes Mg, Ca and Cu. In the anode material, a mass content of Mg is m_{Mg}, a mass content of Ca is m_{Ca}, and a mass content of Cu is m_{Cu}, where 0<m_{Ca}/m_{Mg}<0.1, and 0<m_{Cu}/m_{Mg}<0.01.

In the anode material of the present application, Mg, Ca and Cu are introduced into the active material, and a ratio of Mg, Ca and Cu is limited within a proper range, so that the initial coulombic efficiency, conductivity and cycle performance of the anode material are improved comprehensively. In the present application, the introduced Mg and Ca help to reduce a content of silicon oxide in the anode material so that the amount of lithium consumed by the silicon oxide in the anode material is reduced, and the initial coulombic efficiency of the anode material is improved.

It should be noted that from the analysis of the data and beneficial effects of the examples, the applicant may conclude that the technical problem of the present application can be solved by limiting the contents of Mg, Ca and Cu to the above ranges in the present application without limiting the specific forms of Mg, Ca and Cu.

In the anode material of the present application, M (M=Mg, Ca, or Cu) is dispersed in the silicon oxide material in the form of atoms. Due to a lower atomic electronegativity than O and Si, M can bond with O or Si to form M-Si—O, M-O, M-Si, or the like, i.e., form at least one of a silicate of M, an oxide of M, or a silicide of M. For example: Ca atoms may form at least one of calcium silicate, calcium oxide, calcium silicide, or the like.

In the anode material of the present application, Mg is present in the form of magnesium silicate; and compared with Mg atoms, Ca atoms have lower electronegativity and may produce higher bond energy with O and/or Si atoms, which is more favorable for stabilizing an atomic cluster structure, so that the structural stability and cycle performance of the anode material are improved.

As a doping element, Cu may be present in the anode material in the form of at least one compound of copper oxide, cuprous oxide, cupric silicate, or copper silicide. Compared with Mg atoms, Cu atoms in the Cu compound have obviously more electron shells and a lower electron transition energy barrier, i.e., a lower capture capability of electrons, which means that an outermost layer of free electrons has good mobility. Therefore, the doping of Cu can improve the conductivity and cycle performance of the silicon oxide anode material.

In the anode material of the present application, proper amounts of Mg, Ca and Cu are introduced into the active material, where Mg is present in the form of magnesium silicate, Ca and Cu are present in the form of metal compounds, and the metal oxide includes at least one of metal silicate, metal oxide or metal silicide, so that the initial coulombic efficiency, conductivity and cycle performance of the anode material are improved comprehensively.

In some embodiments, the introduced Mg and Ca of the proper mass content ratio are present in the anode material in the forms of magnesium silicate and calcium silicate, where the calcium silicate is more stable than the magnesium silicate. Compared with pure magnesium silicate, the coexistence of magnesium silicate and calcium silicate of proper proportions can further improve the structural stability of the anode material, so that an anode sheet of the battery made of the anode material can maintain higher conductivity even after long-term charge and discharge cycles. In other words, the cycle performance of the anode material is improved. In addition, the introduced proper content of Cu may be combined with Si and present in the form of copper silicide, while a proper amount of copper silicide enables good conductivity and ductility, so that the structural stability and electrical contact effect of the anode material can be enhanced, and the cycle performance and conductivity of the anode material can be further improved.

In the anode material of the present application, m_{Ca}/m_{Mg} may be specifically 0.01, 0.02, 0.03, 0.04, 0.05, 0.06, 0.07, 0.08, 0.09, 0.099, or the like, or may be any other value within that range, which is not limited herein. By limiting the value of m_{Ca}/m_{Mg} to the above range, a silicon crystallite size generated by the silicon oxide reaction can be controlled at or within 15 nm, thereby improving the cycle performance of the anode material.

In the anode material of the present application, m_{Cu}/m_{Mg} may be specifically 0.001, 0.002, 0.003, 0.004, 0.005, 0.006, 0.007, 0.008, 0.009, 0.0099, or the like, or may be any other value within that range, which is not limited herein. Under these conditions, the content of the possibly generated copper silicide can be better controlled, thereby improving the capacity of the anode material.

For similar reasons, it is further preferable in some embodiments that in the anode material, 0.028≤m_{Ca}/m_{Mg}≤0.099, and 0.0008≤m_{Cu}/m_{Mg}≤0.0099.

In some embodiments, Si, O, Mg, Ca and Cu are uniformly distributed in the active material, which can help to improve the structural stability at different positions of the anode material, and further improve the overall cycle performance of the anode material.

In some embodiments, in the anode material, 0<m_{Mg}<25%, and m_{Mg} may be specifically 0.01%, 1%, 5%, 10%, 15%, 20%, 24.99%, or the like, or may be any other value within that range, which is not limited herein. By further limiting the value of m_{Mg} within the above range, the present application can help to improve the cycle performance and conductivity of the anode material without significantly affecting the capacity of the anode material.

For similar reasons, it is further preferable in some embodiments that in the anode material, 5%≤m_{Mg}≤15%, and preferably 7.8%≤m_{Mg}≤8.7%.

In some embodiments, in the anode material, 0<m_{Ca}<10%, and m_{Ca} may be specifically 0.01%, 1%, 2%, 4%, 6%, 8%, 9.99%, or the like, or may be any other value within that range, which is not limited herein. By further limiting the value of m_{Ca} within the above range, the present application can further help to slow down the reaction process between Ca and the silicon oxide in the material, so that the Si grain size can be further reduced, and the anode material has better cycle performance.

For similar reasons, it is further preferable in some embodiments that in the anode material, 0.2%≤m_{Ca}≤0.8%.

In some embodiments, in the anode material, 0<m_{Cu}<0.5%, and m_{Cu} may be specifically 0.01%, 0.1%, 0.2%, 0.3%, 0.4%, 0.499%, or the like, or may be any other value within that range, which is not limited herein. By further limiting the value of m_{Cu} within the above range, the present application can help to provide a more appropriate amount of copper silicide in the anode material, so that the cycle performance and conductivity of the anode material are improved through good conductivity and ductility, and the capacity reduction caused by the excessive copper silicide is further alleviated.

For similar reasons, it is further preferable in some embodiments that in the anode material, 0.007%≤m_{Cu}≤0.08%.

In some embodiments, a mass content of silicon in the anode material is 24% to 36%, which may be specifically 24%, 28%, 30%, 32%, 34%, 36%, or the like, or may be any other value within that range, which is not limited herein.

In some embodiments, a mass content of oxygen in the anode material is 44% to 59%, which may be specifically 44%, 48%, 50%, 53%, 55%, 57%, 59%, or the like, or may be any other value within that range, which is not limited herein.

By further limiting the mass contents of silicon and oxygen in the anode material within the above ranges, the present application can facilitate full reaction of Si and O with the introduced Mg, Ca and Cu to comprehensively improve the initial coulombic efficiency, conductivity and cycle performance of the anode material, while further reduce the lithium consumed by the silicon oxide in the anode material, so that the initial coulombic efficiency of the anode material is better improved.

In some embodiments, in the active material, Si is present in the form of elemental silicon and/or silicon oxide, and a Si crystallite size on the (220) crystal plane in the active material is ≤15 nm. The relatively small Si crystallite size can help to further improve the cycle performance of the anode material.

In some embodiments, in the active material, Si is present in the form of at least one of amorphous silicon, crystalline silicon, silicon oxide, a silicon alloy, or a composite of crystalline silicon and amorphous silicon.

In some embodiments, the active material includes a silicon oxide having a general formula SiOₓ, where 0<x≤2, and x may be specifically 0.1, 0.5, 1, 1.5, 2, or the like, or may be any other value within that range, which is not limited herein.

In some embodiments, the metal M element is present in the form of at least one of a silicate of M, an oxide of M, or a silicide of M.

In some embodiments, the active material includes at least one of calcium silicate, magnesium silicate, or copper silicide.

In some embodiments, the active material further includes elemental copper.

In the present application, the active material is generated from the introduced Mg, Ca and Cu, which can better improve the initial coulombic efficiency of the anode material, and improve the structural stability of the anode material so that the anode material maintains high conductivity after long-term charge-discharge cycles, thereby further improving the cycle performance of the anode material.

In some embodiments, the anode material further includes a carbon material on at least part of a surface of the active material. With the carbon layer on a part of the surface of the active material, formation of a solid electrolyte interphase (SEI) film caused by direct contact of the active material with the electrolyte can reduced, and degradation of the cycle performance of the material can be alleviated.

In some embodiments, the carbon material includes at least one of graphite, graphene, amorphous carbon, diamond-like carbon, carbon nanotubes, or carbon fibers. The carbon material can provide good conductivity while protecting the active material, thereby further improving the conductivity of the anode material. The amorphous carbon is a material which exhibits no characteristic peaks in an XRD pattern formed by pyrolysis of a carbon source. For example, the amorphous carbon may be obtained by decomposing acetylene at 750° C. to 850° C.

In some embodiments, the carbon material forms a carbon layer on the surface of the active material.

In some embodiments, the carbon layer covers the active material so that the volume expansion rate of the anode material can be effectively reduced.

In some embodiments, the carbon layer has a thickness of 50 nm to 200 nm, which may be specifically 50 nm, 80 nm, 110 nm, 140 nm, 170 nm, 200 nm, or the like, or may be any other value within that range, which is not limited herein. With the thickness of the carbon layer limited within the above range, the carbon layer can completely cover the active material to prevent repeatedly generation of an unstable SEI film due to direct contact between the active material and the electrolyte, which may cause excessive consumption of the electrolyte and degradation of the cycle performance of the material, while the carbon layer is also prevented from being too thick and cracking due to the stress of internal particles.

In some embodiments, a mass content of C in the anode material is 1% to 20%, which may be specifically 1%, 4%, 8%, 12%, 16%, 20%, or the like, or may be any other value within that range, which is not limited herein. Under these conditions, a balance between the protective performance and the conductivity of the active material can be achieved, so that better conductivity and cycle performance are both obtained.

In some embodiments, the anode material has a pH of 8 to 10, which may be specifically 8.00, 8.50, 9.00, 9.50, 10, or the like, or may be any other value within that range, which is not limited herein. Under these conditions, the anode material can be adapted to most types of electrolyte, thereby improving the universality of the anode material.

In some embodiments, the anode material has an average particle size D50 of 1 μm to 100 μm, which may be specifically 1 μm, 10 μm, 20 μm, 40 μm, 60 μm, 80 μm, 100 μm, or the like, or may be any other value within that range, which is not limited herein. The proper particle size can facilitate preparation of the material while reducing agglomeration.

In some embodiments, the anode material has a specific surface area of 1 m²/g to 120 m²/g, which may be specifically 1 m²/g, 10 m²/g, 20 m²/g, 40 m²/g, 6 m²/g, 80 m²/g, 100 m²/g, or 120 m²/g, or the like, or may be any other value within that range, which is not limited herein. The proper specific surface area can help to further reduce formation of the SEI film during the initial charge-discharge cycle, thereby further improving the initial coulombic efficiency of the anode material.

As discussed above, in the anode material of the present application, Mg, Ca and Cu are introduced into the active material, and a ratio of Mg, Ca and Cu is limited within a proper range, so that the initial coulombic efficiency, conductivity and cycle performance of the anode material are improved comprehensively.

Specifically, in some embodiments, the initial coulombic efficiency of the anode material is 80% to 95%, preferably 80% to 85%.

In some embodiments, the anode material has a conductivity of 0.5 S/cm to 7 S/cm, preferably 2 S/cm to 7 S/cm.

In some embodiments, a capacity retention after 50 cycles of the anode material is 80% to 90%.

In some embodiments, an electrode sheet expansion rate after 50 cycles of the anode material is 30% to 38%.

An anode material with the above performance parameters is more suitable as a component of a lithium-ion battery to further improve the electrochemical performance of the whole battery.

In a second aspect, the present application further provides a preparation method for an anode material, which is shown in the FIGURE.

In an example of the present application, the preparation method includes:

S1, mixing a raw material of silicon-based active particles with a metal doping source containing M and performing heat treatment on the mixture, and mixing and cooling the formed steam to obtain an active material, where the anode material includes an active material including Si, O and metal M, the metal M includes Mg, Ca and Cu, and in the anode material, a mass content of Mg is m_{Mg}, a mass content of Ca is m_{Ca}, and a mass content of Cu is m_{Cu}, where 0<m_{Ca}/m_{Mg}<0.1, and 0<m_{Cu}/m_{Mg}<0.01.

In the preparation method of the present application, proper amounts of Mg, Ca and Cu are doped into the silicon-based active particles in the process of preparing the active material of the anode material, so that the ratio of Ca, Cu and Mg in the finally prepared anode material is controlled within an ideal range, and the prepared anode material has relatively high initial coulombic efficiency and conductivity, excellent cycle performance, and high lithium intercalation and deintercalation rates.

In the technical solutions of the present application, the introduced Mg and Ca will react with the silicon oxide in the silicon-based active particles to generate elemental silicon, which can help to reduce a content of silicon oxide in the anode material so that the amount of lithium consumed by the silicon oxide in the anode material is reduced, and the initial coulombic efficiency of the anode material is improved. Moreover, after reducing silicon in the silicon oxide, the introduced Mg and Ca can further react with the silicon oxide to generate corresponding magnesium silicate and calcium silicate, the calcium silicate is more stable than the magnesium silicate, and compared with pure magnesium silicate, the coexistence of magnesium silicate and calcium silicate of proper proportions can further improve the structural stability of the anode material, so that an anode sheet of the battery made of the anode material can maintain higher conductivity even after long-term charge and discharge cycles. In other words, the cycle performance of the anode material is improved. In addition, the introduced Cu will further react with the generated elemental silicon to generate a copper silicon compound, so that the amount of free elemental silicon in the anode material is reduced, the structural stability of the anode material and the electrical contact effect among anode material particles are enhanced, and the cycle performance and conductivity of the anode material are further improved.

In the preparation method of the present application, m_{Ca}/m_{Mg} may be specifically 0.01, 0.02, 0.03, 0.04, 0.05, 0.06, 0.07, 0.08, 0.09, 0.099, or the like, or may be any other value within that range, which is not limited herein. By limiting the value of m_{Ca}/m_{Mg} to the above range, a silicon crystallite size generated by the silicon oxide reaction can be controlled at or within 15 nm. When the value of m_{Ca}/m_{Mg} is too large, Ca will react with the silicon oxide more violently, generate a large amount of heat in the reaction process, and produce large sizes of Si crystal grains, resulting in poor cycle performance of the prepared anode material.

In the preparation method of the present application, m_{Cu}/m_{Mg} may be specifically 0.001, 0.002, 0.003, 0.004, 0.005, 0.006, 0.007, 0.008, 0.009, 0.0099, or the like, or may be any other value within that range, which is not limited herein. When the mass content ratio of Cu to Mg is too large, an excessive amount of copper silicide will be generated, which may further cause capacity reduction of the material.

In some embodiments, a mass ratio of a metal doping source of M to the silicon-based active particles is (1 to 35):100, specifically 1:100. 10:100, 20:100, 30:100, 35:100, or the like, or may be any other value within that range, which is not limited herein. With such a mass ratio range, Mg, Ca and Cu can be favorably introduced to generate proper amounts of magnesium silicate, calcium silicate and copper silicon compound so that the cycle performance and conductivity of the anode material are both further improved.

In some embodiments, the metal doping source includes at least one of elemental metal M or a compound containing metal M.

In some embodiments, the metal doping source includes a mixture of an oxide containing metal M and/or a salt containing metal M with a reducing substance.

In some embodiments, the salt containing metal includes at least one of MgCO₃, MgCl₂, CaCO₃, dolomite, or copper-dyed dolomite.

Such a metal doping source is lower in cost and easy to obtain, thereby facilitating further reduction in the preparation cost of the anode material, and making the anode material more suitable for industrial production and applications.

In some embodiments, the raw material of the silicon-based active particles includes at least one of a mixture of Si, SiO_{y} and SiO₂, a mixture of SiO_{y} and Si, or a mixture of Si and SiO₂, where 0<y<2.

In some embodiments, a molar weight of M in the metal doping source is n_{M}, where 0<n_{Ca}/n_{Mg}<1.8, and 0<n_{Cu}/n_{Mg}<0.3. By limiting the molar content ratio of calcium, copper and magnesium in the metal doping source to the above range, the mass content ratio of calcium, copper and magnesium in the active material of the prepared anode material can be ensured to satisfy: 0<m_{Ca}/m_{Mg}<0.1, and 0<m_{Cu}/m_{Mg}<0.01.

In some embodiments, a molar weight of M in the metal doping source is n_{M}, a molar weight of Si in the raw material of the silicon-based active particles is n_{Si}, and n_{M}:n_{Si}=(0.02 to 0.62):1, specifically 0.02:1, 0.1:1, 0.2:1, 0.4:1, 0.62:1 or any ratio therebetween. By limiting the molar ratio of M in the metal doping source to the silicon in the raw material of the silicon-based active particles to the above range, the initial coulombic efficiency, conductivity and cycle performance of the prepared anode material can be greatly and comprehensively improved.

In some embodiments, the heat treatment includes heating a mixture of the raw material of the silicon-based active particles and the metal doping source in a negative pressure environment and keeping the temperature.

In some embodiments, the negative pressure environment has a vacuum degree of 0.001 Pa to 100 Pa, specifically 0.001, 10, 40, 60, 80, 100, or any value therebetween.

In some embodiments, the heating temperature is 1100° C. to 1600° C., specifically 1100° C., 1200° C., 1300° C., 1400° C., 1500° C., or any value therebetween.

In some embodiments, the temperature is kept for 4 h to 30 h, specifically 4 h, 12 h, 20 h, 25 h, 30 h, or any value therebetween.

In some embodiments, the cooling temperature is 100° C. or less, specifically 10° C., 20° C., 30° C., 40° C., 50° C., 60° C., 70° C., 80° C., 90° C., 98° C., or any value in between.

Under the above heat treatment conditions, proper amounts of Mg, Ca and Cu can be introduced into the silicon-based active particles more favorably, and distributed uniformly in the anode material under the action of heat, so that a better effect of improving the initial coulombic efficiency, conductivity and cycle performance of the anode material is obtained.

In some embodiments, the method further includes performing pulverization and/or classification on the cooled active material.

In some embodiments, the pulverization is implemented by any one or more of ball milling, jet milling, crushing, or spheronization.

In some embodiments, the classification is implemented to select a material having an average particle size D50 of 1 μm to 100 μm and a specific surface area of 1 m²/g to 120 m²/g.

In some embodiments, pulverization of the cooled active material is performed before classification.

Through the pulverization and the classification, an anode material of proper particle size and specific surface area can be obtained more conveniently, which can further facilitate preparation of the material, and reduce formation of the SEI film during the initial charge-discharge cycle, thereby improving the initial coulombic efficiency of the anode material.

In some embodiments, the method further includes: performing carbon coating on the cooled active material to obtain the anode material.

In some embodiments, pulverization, classification and coating on the cooled active material are sequentially performed.

In some embodiments, the carbon coating includes any one of gas-phase carbon coating, liquid-phase carbon coating, or solid-phase carbon coating.

In some embodiments, the coating material used in the carbon coating is a carbon material including at least one of graphite, graphene, amorphous carbon, diamond-like carbon, carbon nanotubes, or carbon fibers.

In some embodiments, the coating thickness of the carbon coating is 50 nm to 200 nm, specifically 50 nm, 100 nm, 150 nm, 200 nm, or any value therebetween.

In some embodiments, the carbon coating includes: placing the active material into a CVD furnace, introducing argon externally as a protective gas, introducing acetylene internally as a carbon source, heating at 800° C. to decompose the acetylene, and coating amorphous carbon on a surface of the active material to obtain the anode material.

In some embodiments, a mass content ratio of the carbon material to the active material is (1-20):(80-99), which may be specifically 1:99, 1:80, 5:80, 10:80, 15:80, 20:80, or any ratio therebetween.

With the surface of the active material coated with the carbon material, formation of an SEI film caused by direct contact of the active material with the electrolyte can be reduced, and excessive consumption of the electrolyte and degradation of the cycle performance of the material can be alleviated. Further, such a material can provide good conductivity while protecting the active material, thereby further improving the conductivity of the anode material, and can provide a proper carbon layer to reduce cracking caused by the internal particle stress.

In a third aspect, the present application further provides a lithium-ion battery, including the anode material as described above, or including an anode material prepared by the above preparation method. The lithium-ion battery of the present application has the properties of high initial coulombic efficiency, high conductivity, excellent cycle performance and the like.

The examples of the present application are further illustrated below in the context of several examples. The examples of the present application are not limited to the following specific examples. The present application may be modified and implemented as appropriate within the scope of the main claims.

### Example 1

### Preparation of Anode Material

(1) Preparation of active material: taking and mixing 5 kg of SiO, 0.48 kg of Mg, 0.2 kg of Ca and 0.01 kg of Cu for 30 min, and then placing the mixture into a vacuum furnace; heating to 1350° C. under vacuum with a vacuum degree of 1 Pa and keeping the temperature for 20 h to generate SiO steam, Mg steam, Ca steam and Cu steam, mixing the various types of steam uniformly, and condensing the mixture to below 100° C. to obtain 4 kg of the active material. The active material includes silicon, silicon oxide, calcium silicate, magnesium silicate and copper silicide, and the Si crystallite size calculated according to an XRD test pattern and the Scherrer equation is 6 nm.

(2) Powdering: taking 3 kg of the active material obtained in (1) for crushing, ball milling, classification and the like, to control an average particle size D50 of the material to about 4 μm and a specific surface area to 30 m²/g.

(3) Carbon coating: placing the active material obtained after the powdering in (2) into a CVD furnace, introducing argon externally as a protective gas, introducing acetylene internally as a carbon source, heating at 800° C. to decompose the acetylene, and coating 5% carbon on a surface of the active material to obtain the anode material. The carbon material is amorphous carbon, and the anode material has a pH of 8.5.

Elemental quantitative analysis is performed on the anode material obtained in example 1 with an inductively coupled plasma optical emission spectrometer, and the detection results and m_{Ca}/m_{Mg} and m_{Cu}/m_{Mg} calculated from the detection results are shown in table 1.

Further, an electrochemical performance test is performed on the anode material obtained in example 1, and the test results are shown in tables 2 and 3.

### Example 2

### Preparation of Anode Material

(1) Preparation of active material: taking and mixing 3 kg of silicon powder, 6 kg of SiO₂, 3 kg of calcined copper-dyed dolomite and 3 kg of Mg for 30 min, and then placing the mixture into a vacuum furnace; heating to 1350° C. under vacuum with a vacuum degree of 1 Pa and keeping the temperature for 20 h to generate SiO steam, Mg steam, Ca steam and Cu steam, mixing the various types of steam uniformly, and condensing the mixture to below 100° C. to obtain 4 kg of the active material.

(2) Powdering: taking 3 kg of the active material obtained in (1) for crushing, ball milling, classification and the like, to control an average particle size D50 of the material to about 4 μm and a specific surface area to 33 m²/g.

(3) Carbon coating: placing the active material obtained after the powdering in (2) into a CVD furnace, introducing argon externally as a protective gas, introducing acetylene internally as a carbon source, heating at 800° C. to decompose the acetylene, and coating 5% carbon on a surface of the active material to obtain the anode material. The carbon material is amorphous carbon, and the anode material has a pH of 8.9.

Elemental quantitative analysis is performed on the anode material obtained in example 2 with an inductively coupled plasma optical emission spectrometer, and the detection results and m_{Ca}/m_{Mg} and m_{Cu}/m_{Mg} calculated from the detection results are shown in table 1.

Further, an electrochemical performance test is performed on the anode material obtained in example 2, and the test results are shown in tables 2 and 3.

### Example 3

### Preparation of Anode Material

(1) Preparation of active material: taking and mixing 5 kg of SiO, 0.5 kg of Mg, 0.8 kg of Ca and 0.1 kg of Cu for 30 min, and then placing the mixture into a vacuum furnace; heating to 1350° C. under vacuum with a vacuum degree of 1 Pa and keeping the temperature for 20 h to generate SiO steam, Mg steam, Ca steam and Cu steam, mixing the various types of steam uniformly, and condensing the mixture to below 100° C. to obtain 4 kg of the active material.

(2) Powdering: taking 3 kg of the active material obtained in (1) for crushing, ball milling, classification and the like, to control an average particle size D50 of the material to about 4 μm and a specific surface area to 28 m²/g.

(3) Carbon coating: placing the active material obtained after the powdering in (2) into a CVD furnace, introducing argon externally as a protective gas, introducing acetylene internally as a carbon source, heating at 800° C. to decompose the acetylene, and coating 5% carbon on a surface of the active material to obtain the anode material. The carbon material is amorphous carbon, and the anode material has a pH of 8.6.

Elemental quantitative analysis is performed on the anode material obtained in example 3 with an inductively coupled plasma optical emission spectrometer, and the detection results and m_{Ca}/m_{Mg} and m_{Cu}/m_{Mg} calculated from the detection results are shown in table 1.

Further, an electrochemical performance test is performed on the anode material obtained in example 3, and the test results are shown in tables 2 and 3.

### Example 4

### Preparation of Anode Material

(1) Preparation of active material: taking and mixing 5 kg of SiO, 0.5 kg of Mg, 0.7 kg of Ca and 0.01 kg of Cu for 30 min, and then placing the mixture into a vacuum furnace; heating to 1350° C. under vacuum with a vacuum degree of 1.5 Pa and keeping the temperature for 20 h to generate SiO steam, Mg steam, Ca steam and Cu steam, mixing the various types of steam uniformly, and condensing the mixture to below 100° C. to obtain 4 kg of the active material.

(2) Powdering: taking 3 kg of the active material obtained in (1) for crushing, ball milling, classification and the like, to control an average particle size D50 of the material to about 4 μm and a specific surface area to 31 m²/g.

(3) Carbon coating: placing the active material obtained after the powdering in (2) into a CVD furnace, introducing argon externally as a protective gas, introducing acetylene internally as a carbon source, heating at 800° C. to decompose the acetylene, and coating 5% carbon on a surface of the active material to obtain the anode material. The carbon material is amorphous carbon, and the anode material has a pH of 8.6.

Elemental quantitative analysis is performed on the anode material obtained in example 4 with an inductively coupled plasma optical emission spectrometer, and the detection results and m_{Ca}/m_{Mg} and m_{Cu}/m_{Mg} calculated from the detection results are shown in table 1.

Further, an electrochemical performance test is performed on the anode material obtained in example 4, and the test results are shown in tables 2 and 3.

### Example 5

### Preparation of Anode Material

(1) Preparation of active material: taking and mixing 5 kg of SiO, 0.5 kg of Mg, 1.5 kg of Ca and 0.06 kg of Cu for 30 min, and then placing the mixture into a vacuum furnace; heating to 1350° C. under vacuum with a vacuum degree of 1 Pa and keeping the temperature for 20 h to generate SiO steam, Mg steam, Ca steam and Cu steam, mixing the various types of steam uniformly, and condensing the mixture to below 100° C. to obtain 4 kg of the active material.

(2) Powdering: taking 3 kg of the active material obtained in (1) for crushing, ball milling, classification and the like, to control an average particle size D50 of the material to about 4 μm and a specific surface area to 26 m²/g.

(3) Carbon coating: placing the active material obtained after the powdering in (2) into a CVD furnace, introducing argon externally as a protective gas, introducing acetylene internally as a carbon source, heating at 800° C. to decompose the acetylene, and coating 5% carbon on a surface of the active material to obtain the anode material. The carbon material is amorphous carbon, and the anode material has a pH of 8.8.

Elemental quantitative analysis is performed on the anode material obtained in example 5 with an inductively coupled plasma optical emission spectrometer, and the detection results and m_{Ca}/m_{Mg} and m_{Cu}/m_{Mg} calculated from the detection results are shown in table 1.

Further, an electrochemical performance test is performed on the anode material obtained in example 5, and the test results are shown in tables 2 and 3.

### Example 6

### Preparation of Anode Material

(1) Preparation of active material: taking and mixing 5 kg of SiO, 0.48 kg of Mg, 0.8 kg of Ca and 0.4 kg of Cu for 30 min, and then placing the mixture into a vacuum furnace; heating to 1350° C. under vacuum with a vacuum degree of 1 Pa and keeping the temperature for 20 h to generate SiO steam, Mg steam, Ca steam and Cu steam, mixing the various types of steam uniformly, and condensing the mixture to below 100° C. to obtain 4 kg of the active material.

(2) Powdering: taking 3 kg of the active material obtained in (1) for crushing, ball milling, classification and the like, to control an average particle size D50 of the material to about 4 μm and a specific surface area to 37 m²/g.

(3) Carbon coating: placing the active material obtained after the powdering in (2) into a CVD furnace, introducing argon externally as a protective gas, introducing acetylene internally as a carbon source, heating at 800° C. to decompose the acetylene, and coating 5% carbon on a surface of the active material to obtain the anode material. The carbon material is amorphous carbon, and the anode material has a pH of 9.

Elemental quantitative analysis is performed on the anode material obtained in example 6 with an inductively coupled plasma optical emission spectrometer, and the detection results and m_{Ca}/m_{Mg} and m_{Cu}/m_{Mg} calculated from the detection results are shown in table 1.

Further, an electrochemical performance test is performed on the anode material obtained in example 6, and the test results are shown in tables 2 and 3.

### Example 7

### Preparation of Anode Material

(1) Preparation of active material: taking and mixing 5 kg of SiO, 0.48 kg of Mg, 0.2 kg of Ca and 0.01 kg of Cu for 30 min, and then placing the mixture into a vacuum furnace; heating to 1100° C. under vacuum with a vacuum degree of 0.001 Pa and keeping the temperature for 30 h to generate SiO steam, Mg steam, Ca steam and Cu steam, mixing the various types of steam uniformly, and condensing the mixture to below 100° C. to obtain 4 kg of the active material.

(2) Powdering: taking 3 kg of the active material obtained in (1) for crushing, ball milling, classification and the like, to control an average particle size D50 of the material to about 1 μm and a specific surface area to 120 m²/g.

(3) Carbon coating: placing the active material obtained after the powdering in (2) into a CVD furnace, introducing argon externally as a protective gas, introducing acetylene internally as a carbon source, heating at 750° C. to decompose the acetylene, and coating 1% carbon on a surface of the active material to obtain the anode material. The carbon material includes amorphous carbon, the carbon layer has a thickness of 50 nm, and the anode material has a pH of 8.

Elemental quantitative analysis is performed on the anode material obtained in example 7 with an inductively coupled plasma optical emission spectrometer, and the detection results and m_{Ca}/m_{Mg} and m_{Cu}/m_{Mg} calculated from the detection results are shown in table 1.

Further, an electrochemical performance test is performed on the anode material obtained in example 7, and the test results are shown in tables 2 and 3.

### Example 8

### Preparation of Anode Material

(1) Preparation of active material: taking and mixing 5 kg of SiO, 0.48 kg of Mg, 0.2 kg of Ca and 0.01 kg of Cu for 30 min, and then placing the mixture into a vacuum furnace; heating to 1600° C. under vacuum with a vacuum degree of 100 Pa and keeping the temperature for 4 h to generate SiO steam, Mg steam, Ca steam and Cu steam, mixing the various types of steam uniformly, and condensing the mixture to below 100° C. to obtain 4 kg of the active material.

(2) Powdering: taking 3 kg of the active material obtained in (1) for crushing, ball milling, classification and the like, to control an average particle size D50 of the material to about 100 μm and a specific surface area to 1 m²/g.

(3) Carbon coating: placing the active material obtained after the powdering in (2) into a CVD furnace, introducing argon externally as a protective gas, introducing acetylene internally as a carbon source, heating at 850° C. to decompose the acetylene, and coating 20% carbon on a surface of the active material to obtain the anode material. The carbon material includes amorphous carbon, the carbon layer has a thickness of 200 nm, and the anode material has a pH of 10.

Elemental quantitative analysis is performed on the anode material obtained in example 8 with an inductively coupled plasma optical emission spectrometer, and the detection results and m_{Ca}/m_{Mg} and m_{Cu}/m_{Mg} calculated from the detection results are shown in table 1.

Further, an electrochemical performance test is performed on the anode material obtained in example 8, and the test results are shown in tables 2 and 3.

### Comparative Example 1

This comparative example differs from example 1 in that: the raw material added in step (1) includes 5 kg of SiO and 0.5 kg of Mg.

### Comparative Example 2

This comparative example differs from example 1 in that: the raw material added in step (1) includes 5 kg of SiO, 0.5 kg of Mg and 0.2 kg of Ca.

### Comparative Example 3

This comparative example differs from example 1 in that: the raw material added in step (1) includes 5 kg of SiO, 0.5 kg of Mg, 0.2 kg of Ca and 0.2 kg of Cu.

### Comparative Example 4

This comparative example differs from example 1 in that: the raw material added in step (1) includes 5 kg of SiO, 0.5 kg of Mg, 0.8 kg of Ca and 0.01 kg of Cu.

### Comparative Example 5

This comparative example differs from example 1 in that: the raw material added in step (1) includes 5 kg of SiO, 0.5 kg of Mg and 0.6 kg of Cu.

The test method includes the following steps:
1. Element contents: performing elemental quantitative analysis on the contents of Ca, Mg, and Cu elements in the anode material using an inductively coupled plasma optical emission spectrometer (Agilent 5800 ICP-OES).

The oxygen content in the anode material is tested using an oxygen-nitrogen-hydrogen analyzer (ONH2000), with specific test steps as follows: Weigh 10-11 mg of the sample to be tested using a one-hundred-thousandth balance, wrap the sample to be tested with an appropriate amount of pretreated aluminum foil (serving as a flux), and put the wrapped sample into a graphite crucible under a helium flow. Heat the crucible to approximately 2300° C. to melt the sample; the oxygen in the sample to be tested is precipitated in the form of carbon monoxide or carbon dioxide. After being separated from other gaseous products, the oxygen-containing gas is introduced into an infrared detector for determination. During instrument calibration, a standard sample with an oxygen content similar to that of the sample to be tested should be selected, and each sample should be tested in parallel three times, with the average value taken as the final result.

The carbon content in the anode material is tested using an infrared carbon-sulfur analyzer (Model: Bruker G4 ICARUS HF, Germany), with specific test steps as follows: Accurately weigh 0.05-0.1 g of the sample using a one-hundred-thousandth balance, place it in a ceramic crucible, and spread it evenly. Then add 1.5 g of multi-component carbon-free flux, and put the crucible into a high-frequency heating environment under oxygen-rich conditions. All carbon elements in the sample are fully oxidized to carbon dioxide gas; after purification treatment, the carbon dioxide gas is introduced into a carbon detection cell. The strongest absorption signal of CO₂ for infrared radiation at 4.26 μm is converted into an electrical signal by the detector, and the signal is processed by a computer to output the final test result. For specific operation details, reference can be made to the carbon content test method specified in GB/T 3074.1-2013 Determination Methods for Graphite Electrodes.
2. Si crystallite size: tested using an X-ray diffractometer (PANalytical X′pert PRO). The sample is ground to ≤75 μm with an agate mortar, uniformly filled into a sample holder and compacted, and the sample stage is activated for rotation (15 rpm). The test is conducted with Cu Kα radiation (λ=0.15406 nm), covering a scanning range of 10°-90°, with a step size of 0.013° and a scanning speed of 16.67°/min. After the test, the background is subtracted using HighScore software, the Kα2 peak is separated, and the instrumental broadening is deducted (calibrated with the NIST SRM 660a standard sample). The pseudo-Voigt function is used to fit the (220) crystal plane peak of Si (at 47.3°) to obtain the full width at half maximum (FWHM) R (in radians). The Si crystallite size is calculated via the Scherrer equation (with K=0.94) using the formula: D=0.94×0.15406/(β cos θ). Three sample areas are tested, the average value of 9 test results is taken, and the relative standard deviation (RSD) is required to be ≤5%.
3. Thickness of carbon material: fixing the anode material on a sample stage with conductive adhesive, and preparing a flat cross-section using an argon ion mill (ion beam energy of 5 keV, milling angle of 10°, milling time of 2 hours). Observe the cross-section with a scanning electron microscope (SEM, accelerating voltage of 10 kV, working distance of 8 mm, backscattered electron detector). Select 5 clear images at different positions, uniformly select 15 points on each image, and measure the distance from the interface between the carbon layer and the active material to the outer surface of the carbon layer. Take the average value of all measured points as the thickness of the carbon material.
4. pH: reference to GB/T 24533-2019 “Graphite Negative Electrode Materials for Lithium-ion Batteries, testing the anode material with a Mettler Toledo pH meter to obtain a pH of the material.
5. Average particle size D50: performing particle size analysis on the anode material by a Malvern Panalytical mastersizer3000 laser diffraction particle size analyzer to obtain the average particle size D50, which represents volume cumulative distribution.
6. Specific surface area: performing specific surface area analysis on the anode material by a Micromeritics Tristar 3020 with nitrogen as an absorption/desorption gas to obtain the specific surface area.
7. Powder conductivity: testing a volume resistivity of the anode material powder by a four-probe method. The testing equipment is a powder conductivity meter from Mitsubishi Chemical (Japan), with the model number MCP-PD51. The testing parameters are as follows: the initial resistance order of magnitude can be set to −3, the voltage limit can be set to 10V, and under a pressure of 20 kN, the thickness of the sample is 3-5 mm. Resistances of the powder under five pressure points, i.e., 4KN, 8KN, 12KN, 16KN and 20KN, are respectively tested by an instrument, and then the conductivity and resistivity of the anode material powder are automatically calculated by a computer. Table 3 shows the conductivity under the pressure of 20 KN.
8. Test of electrical properties:

A coin cell is assembled according to BTRTC/ZY/01-020 “Coin Cell Method Operating Instruction Manual”, which specifically includes: dissolving an anode material, conductive carbon black and a polyacrylic acid binder into deionized water according to a mass ratio of 75:15:10, and uniformly dispersing the mixture by a high-speed disperser with the following stirring parameters: firstly stirring the mixture for 20 s at a rotating speed of 800 r/min, and then for 5 min at a rotating speed of 2000 r/min. The test further includes: then wiping a surface of a copper foil with dust-free cloth stained with absolute ethyl alcohol to remove oil stains, coating a slurry uniformly on the copper foil by an automatic coating machine with a 200 μm coater at a speed of 20 mm/s, drying the copper foil in a blast drying oven at 95° C. for 0.5 h, transferring the copper foil to a vacuum drying oven at 130° C. for 8 h, manufacturing the copper foil into electrode sheets each with φ=16 mm by a sheet punching machine, and weighing, subpackaging, and transferring the electrode sheets into a glove box filled with argon for cell assembly. The electrode is a metal lithium sheet, and the separator is a PP-PE-PP composite membrane with a diameter of 19.2 mm. A component ratio of the electrolyte is EC/EMC/DMC=1/1/1, and a concentration of the lithium salt (LiPF₆) is 1.05 mol/L.

(1) Lithium intercalation capacity: under room temperature conditions, charging at a constant current of 0.1C and limiting a charging voltage to 0.005V to 1.5V, to obtain a capacity as the lithium intercalation capacity.

(2) Lithium deintercalation capacity: under room temperature conditions, discharging at a constant current of 0.1C and limiting a discharge voltage to 1.5V to 0.005V, to obtain a capacity serving as the lithium deintercalation capacity.

(3) Initial coulombic efficiency: multiplying a ratio of the lithium intercalation capacity after an initial charging to the lithium deintercalation capacity after an initial discharge by 100%.

(4) Cycle performance: manufacturing the anode materials prepared in the examples and the comparative examples into batteries which are tested by a coin cell charging and discharging device, in cycle 1, discharging at 0.1C to 0.01V, discharging in an arithmetically decreasing manner at 0.01C to 0.01V, discharging at 0.01C to 0.005V, and charging at 0.1C to 1.5V; in cycle 2, discharging at 0.2C to 0.01V, discharging in an arithmetically decreasing manner at 0.02C to 0.01V, discharging at 0.02C to 0.005V, and charging at 0.2C to 1.5V; in cycle 3, discharging at 0.5C to 0.01V, discharging in an arithmetically decreasing manner at 0.05C to 0.01V, discharging at 0.05C to 0.005V, and charging at 0.5C to 1.5V; in cycles 4 to 50, discharging at 1C to 0.01V, discharging in an arithmetically decreasing manner at 0.1C to 0.01V, discharging at 0.1C to 0.005V, and charging at 1C to 1.5V; and in cycle 51, discharging at 0.1C to 0.01V, discharging in an arithmetically decreasing manner at 0.01C to 0.01V, and discharging at 0.01C to 0.005V.

(5) Expansion rate of electrode sheet: under room temperature conditions, testing and recording a thickness of the manufactured electrode sheet by a screw micrometer, and then performing charge-discharge cycles on a battery assembled with the electrode sheet; disassembling the battery after a certain number of cycles, and testing the thickness of the electrode sheet by the screw micrometer; and taking a ratio of a thickness increment of the electrode sheet after the cycles to the thickness of the electrode sheet before the cycles as an expansion rate of the electrode sheet.

### Testing Results:

The testing results of element contents in the anode materials prepared in examples 1 to 8 and comparative examples 1 to 5 are shown in table 1 below, where in each anode material, in addition to Ca, Mg and Cu, the anode material further includes Si, O and C, a mass content of silicon is 24% to 36%, a mass content of oxygen is 44% to 59%, and the remainder is C.

TABLE 1

| | Elemental mass content (%) | | | m_{Ca}/ | m_{Cu}/ |
|---|---|---|---|---|---|
| Sample | Ca | Mg | Cu | m_{Mg} | m_{Mg} |
| Example 1 | 0.38 | 8.21 | 0.03 | 0.046 | 0.0037 |
| Example 2 | 0.22 | 7.83 | 0.02 | 0.028 | 0.0026 |
| Example 3 | 0.73 | 8.71 | 0.08 | 0.084 | 0.0092 |
| Example 4 | 0.27 | 8.53 | 0.007 | 0.032 | 0.0008 |
| Example 5 | 0.83 | 8.36 | 0.04 | 0.099 | 0.0048 |
| Example 6 | 0.31 | 8.08 | 0.08 | 0.038 | 0.0099 |
| Example 7 | Same as example 1 | | | | |
| Example 8 | Same as example 1 | | | | |
| Comparative example 1 | / | 8.64 | / | / | |
| Comparative example 2 | 0.31 | 8.32 | / | 0.038 | / |
| Comparative example 3 | 0.21 | 8.49 | 0.11 | 0.025 | 0.0129 |
| Comparative example 4 | 0.88 | 8.37 | 0.02 | 0.105 | 0.0024 |
| Comparative example 5 | / | 8.38 | 0.16 | / | 0.019 |

The testing results of electrical properties of the anode materials prepared in examples 1 to 8 and comparative examples 1 to 5 are shown in table 2 below:

TABLE 2

| | Lithium | Lithium | Initial |
|---|---|---|---|
| | intercalation | deintercalation | coulombic |
| Sample | capacity (mAh/g) | capacity (mAh/g) | efficiency (%) |
| Example 1 | 1677 | 1410 | 84.1 |
| Example 2 | 1708 | 1416 | 82.9 |
| Example 3 | 1637 | 1383 | 84.5 |
| Example 4 | 1687 | 1422 | 84.3 |
| Example 5 | 1680 | 1413 | 84.1 |
| Example 6 | 1652 | 1389 | 83.6 |
| Example 7 | 1634 | 1381 | 82.7 |
| Example 8 | 1632 | 1379 | 82.8 |
| Comparative | 1716 | 1428 | 83.2 |
| example 1 | | | |
| Comparative | 1688 | 1423 | 84.3 |
| example 2 | | | |
| Comparative | 1689 | 1388 | 82.2 |
| example 3 | | | |
| Comparative | 1651 | 1402 | 84.9 |
| example 4 | | | |
| Comparative | 1603 | 1322 | 83.1 |
| example 5 | | | |

The testing results of conductivity and cycle expansion performance of the anode materials prepared in examples 1 to 8 and comparative examples 1 to 5 are shown in table 3 below:

TABLE 3

| | Con- | Capacity | Capacity | Electrode sheet |
|---|---|---|---|---|
| | ductivity | retention after | retention after | expansion rate |
| Sample | (S/cm) | 30 cycles (%) | 50 cycles (%) | after 50 cycles (%) |
| Example 1 | 3.2 | 91.1 | 87.6 | 33.1 |
| Example 2 | 3.0 | 91.0 | 87.7 | 33.4 |
| Example 3 | 5.4 | 89.3 | 86.5 | 33.5 |
| Example 4 | 2.9 | 88.6 | 86.1 | 34.3 |
| Example 5 | 4.3 | 91.4 | 88.5 | 33.2 |
| Example 6 | 6.1 | 92.3 | 89.0 | 34.9 |
| Example 7 | 2.8 | 88.4 | 85.9 | 35.2 |
| Example 8 | 2.9 | 88.5 | 85.7 | 35.1 |
| Comparative | 0.9 | 84.7 | 81.6 | 39.3 |
| example 1 | | | | |
| Comparative | 1.0 | 87.0 | 82.9 | 38.7 |
| example 2 | | | | |
| Comparative | 10.3 | 88.2 | 82.2 | 38.0 |
| example 3 | | | | |
| Comparative | 2.2 | 88.5 | 85.4 | 37.2 |
| example 4 | | | | |
| Comparative | 10.9 | 88.9 | 82.0 | 38.4 |
| example 5 | | | | |

After analysis in conjunction with tables 1, 2 and 3, it is concluded that:

Comparing comparative examples 1, 2 and 5 with example 1, it can be seen that instead of an anode material having only one or two of Ca, Mg and Cu in the active material, the active material of the anode material according to the present application contains all the three elements Ca, Mg and Cu at the same time, which can help to reduce the volume expansion rate of the material and increase a ratio of lithium intercalation capacity to lithium deintercalation capacity, while comprehensively improving the initial coulombic efficiency, conductivity and cycle performance of the material. Compared with example 1, although comparative example 5 has a higher conductivity, the cycle expansion rate is also significantly increased, thereby greatly limiting applications of the anode material. A specific cause is rooted in that: in comparative example 5, m_{Cu}/m_{Mg} is notably increased, causing a notably increased content of copper silicide in the anode material, and thus an increased conductivity of the anode material. Meanwhile, m_{Ca}/m_{Mg} is reduced, causing unbalanced proportions of magnesium silicate and calcium silicate in the anode material, so that the structural stability of the anode material is reduced, and the cycle performance of the anode material is also obviously reduced. In examples 7 and 8, the preparation process of the coating layer is adjusted, and since the content of M is still adjusted within the range limited in the present application, the performance of the anode material is not significantly reduced, and the technical problem proposed in the present application can still be solved.

Comparing comparative examples 3 to 4 with examples 1 to 4, it can be seen that when the mass content ratios of Ca to Mg and Cu to Mg in the prepared anode material satisfy: 0<m_{Ca}/m_{Mg}<0.1, and 0<m_{Cu}/m_{Mg}<0.01, the volume expansion rate and the ratio of lithium deintercalation capacity to lithium intercalation capacity of the anode material can be improved, so that the initial coulombic efficiency, conductivity and cycle performance of the material can be comprehensively improved without reducing one or more of the properties due to unbalanced distribution of the elements. Compared with examples 1 to 4, although comparative example 3 has a higher conductivity, the cycle expansion rate is also significantly increased, thereby greatly limiting applications of the anode material. A cause is rooted in that: in comparative example 3, m_{Cu}/m_{Mg} is notably increased, causing an increased content of copper silicide in the anode material, and thus an increased conductivity of the anode material, while the missing of Ca causes significantly reduced structural stability and notably increased cycle expansion rate of the anode material.

The above are merely preferred embodiments of the present application and not intended to limit the present application. Any amendments, equivalent substitutions, improvements, and the like within the spirit and principle of the present application are included in the scope of protection defined by the appended claims of the present application.

What is claimed is:

1. An anode material, wherein the anode material comprises an active material including Si, O and metal M, wherein the metal M includes Mg, Ca and Cu; and in the anode material, a mass content of Mg is m_{Mg}, a mass content of Ca is m_{Ca}, and a mass content of Cu is m_{Cu}, where 0<m_{Ca}/m_{Mg}<0.1, and 0<m_{Cu}/m_{Mg}<0.01.

2. The anode material of claim 1, wherein the anode material has at least one of the following features:
(1) m_{Ca}/m_{Mg} is 0.01, 0.02, 0.03, 0.04, 0.05, 0.06, 0.07, 0.08, 0.09, 0.099, or any value within any range composed of any two of the above range;
(2) m_{Cu}/m_{Mg} is 0.001, 0.002, 0.003, 0.004, 0.005, 0.006, 0.007, 0.008, 0.009, 0.0099, or any value within any range composed of any two of the above range.

3. The anode material of claim 1, wherein the anode material has at least one of the following features:
(1) in the active material, Mg, Ca and Cu are uniformly distributed;
(2) 0<m_{Mg}<25%;
(3) 0<m_{Ca}<10%;
(4) 0<m_{Cu}<0.5%.

4. The anode material of claim 3, wherein the anode material has at least one of the following features:
(1) m_{Mg} is 0.01%, 1%, 5%, 10%, 15%, 20%, 24.99%, or the like, or any value within any range composed of any two of the above range;
(2) m_{Ca} is 0.01%, 1%, 2%, 4%, 6%, 8%, 9.99%, or any value within any range composed of any two of the above range;
(3) m_{Cu} is 0.01%, 0.1%, 0.2%, 0.3%, 0.4%, 0.499%, or the like, or any value within any range composed of any two of the above range.

5. The anode material of claim 1, wherein the anode material has at least one of the following features:
(1) a mass content of silicon in the anode material is 24% to 36%;
(2) a mass content of oxygen in the anode material is 44% to 59%.

6. The anode material of claim 1, wherein the anode material has at least one of the following features:
(1) in the active material, Si is present in the form of elemental silicon and/or silicon oxide, and a Si crystallite size on the (220) crystal plane in the active material is ≤15 nm;
(2) in the active material, Si is present in the form of at least one of amorphous silicon, crystalline silicon, silicon oxide, a silicon alloy, or a composite of crystalline silicon and amorphous silicon.

7. The anode material of claim 1, wherein the active material includes a silicon oxide having a general formula SiOₓ, where 0<x≤2.

8. The anode material of claim 1, wherein the metal M element is present in the form of at least one of a silicate of M, an oxide of M, or a silicide of M.

9. The anode material of claim 8, wherein the active material includes at least one of calcium silicate, magnesium silicate, or copper silicide.

10. The anode material of claim 1, wherein the active material comprises elemental copper.

11. The anode material of claim 3, wherein the anode material has at least one of the following features:
(1) 0.028≤m_{Ca}/m_{Mg}≤0.099, and 0.0008≤m_{Cu}/m_{Mg}≤0.0099;
(2) 5%≤m_{Mg}≤15%;
(3) 0.2%≤m_{Ca}≤0.8%;
(4) 0.007%≤m_{Cu}≤0.08%.

12. The anode material of claim 11, wherein in the anode material, 7.8%≤m_{Mg}≤8.7%.

13. The anode material of claim 1, wherein the anode material further comprises a carbon material on at least part of a surface of the active material.

14. The anode material of claim 13, wherein the anode material has at least one of the following features:
(1) the carbon material includes at least one of graphite, graphene, amorphous carbon, diamond-like carbon, carbon nanotubes, or carbon fibers;
(2) the carbon material forms a carbon layer on the surface of the active material;
(3) the carbon material forms a carbon layer with a thickness of 50 nm to 200 nm on the surface of the active material;
(4) a mass content of C in the anode material is 1% to 20%.

15. The anode material of claim 14, wherein the anode material has at least one of the following features:
(1) the thickness of the carbon layer is 50 nm, 80 nm, 110 nm, 140 nm, 170 nm, 200 nm, or any value within any range composed of any two of the above range;
(2) the mass content of C in the anode material is 1%, 4%, 8%, 12%, 16%, 20%, or any value within any range composed of any two of the above range.

16. The anode material of claim 1, wherein the anode material has at least one of the following features:
(1) the anode material has a pH of 8 to 10;
(2) the anode material has an average particle size D50 of 1 μm to 100 μm;
(3) the anode material has a specific surface area of 1 m²/g to 120 m²/g;
(4) the anode material has a conductivity of 0.5 S/cm to 7 S/cm.

17. The anode material of claim 16, wherein the anode material has a conductivity of 2 S/cm to 7 S/cm.

18. The anode material of claim 16, wherein the pH of the anode material is 8.00, 8.50, 9.00, 9.50, 10, or any value within any range composed of any two of the above range.

19. The anode material of claim 16, wherein the anode material has at least one of the following features:
(1) the average particle size D50 of the anode material is 1 μm, 10 μm, 20 μm, 40 μm, 60 μm, 80 μm, 100 μm, or any value within any range composed of any two of the above range;
(2) the specific surface area of the anode material is 1 m²/g, 10 m²/g, 20 m²/g, 40 m²/g, 6 m²/g, 80 m²/g, 100 m²/g, or 120 m²/g, or any value within any range composed of any two of the above range.

20. A lithium-ion battery, comprising the anode material of claim 1.
